(19) United States
(12) Patent Application Publication
(10) Pub. No.: US 2010/0220697 A1
(43) Pub. Date: Sep. 2, 2010

(54) METHOD AND APPARATUS FOR MULTI-MODE CONVERSATIONS IN WIRELESS NETWORKS

(75) Inventors: Bo Liu, Shanghai (CN); Xiaohui Jin, Shanghai (CN); Xiaoling Shao, Shanghai (CN); Rob Davies, Shanghai (CN); Yonggang Du, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., Eindhoven (NL)

(21) Appl. No.: 11/993,666

(22) PCT Filed: Jun. 29, 2006
(86) PCT No.: PCT/IB2006/052170

§ 371 Date: Dec. 21, 2007

(30) Foreign Application Priority Data
Jun. 30, 2005 (CN) 200510080746.9

(51) Int. Cl. H04W 4/00

(52) U.S. Cl. 370/338; 455/426.1

(57) ABSTRACT

The present invention proposes a method for performing multi-mode conversations for mobile terminals, comprising the steps of: 1)detecting whether there is Wireless Local Area Network (WLAN) available nearby; 2)accessing a network device for correlative location information of another mobile terminal which it intends to communicate with when there is a WLAN available; 3)establishing communication with said another mobile terminal by using said correlative location information via said WLAN after receiving said correlative location information of said another mobile terminal sent back by said network device; and 4)accessing said network device to request updating correlative location information of said mobile terminal when said correlative location information of said mobile terminal changes.

### FIELD OF THE INVENTION

The present invention relates to mobile communication techniques, more particularly relates to method and apparatus for performing multi-mode conversation via instant messaging server in wireless overlay networks.

### BACKGROUND OF THE INVENTION

VoIP (Voice over IP) has become a very important communication method in recent years. This communication method is considered as a substitution of the expensive circuit switching conversation, and it saves cost for terminal users.

Extending this communication method into cellular networks has been taken into account recently. The basic idea is to develop a WLAN nearby and then perform the conversation by using VoIP or other similar techniques. A new generation of cellular terminal supporting WLAN can carry out this method technically. The end-to-end connection between two mobile terminals with the same configuration (for instance, both can access to WLAN) has been tested in recent research. Further research will extend this scheme to allow terminals to have access to traditional connections (terrestrial transmission or cellular transmission) via VoIP which performing over WLAN.

As to end-to-end scheme, one of the problems need to be solved is that terminals need to exchange IP addresses with each other in order to establish a VoIP conversation. Normally, the IP addresses are always assigned dynamically while registering on WLANs. Thus, this method can't generate a static mapping between user number or ID and IP address. In former embodiments the IP address exchange is done through cellular user channel. When two terminals are both in coverage of WLANs, by using simple protocol to detect whether a reliable VoIP conversation can be set up over WLANs. Mark the time when the two terminals are both in the coverage of WLAN with a simple protocol and then examine if it is able to establish a dependable VoIP conversation on WLAN. If so, it will perform a conversation switch from cellular service to VoIP service.

That method is provided that there must be a pre-built cellular link therebetween even these two terminals are all in the coverage of a WLAN.

Now there is a substitutable method of exchanging IP addresses comprising a system that bases on the communication techniques called Instant Message (IM). In an existing embodiment, an IM-based IP address server keeps the information that describes the current mapping between user number and IP address. If an IP address is available, the caller can use said mapping information to establish a call base on VoIP. In practice there is a potential problem that WLAN link must be always active (or in low duty factor mode) for receiving possible calls though said calls hardly happen in a long time. That increases the power cost. Other problems beside increased cost should be taken into account too. Such as the register in WLAN, connection situation, profile managing, etc.

The present invention is to alleviate the drawbacks of the prior art.

### OBJECT AND SUMMARY OF THE INVENTION

It is one of the objects of the present invention to provide an IM-based method and the corresponding system for multi-mode conversation in mobile network.

According to the first aspect of the present invention, a method for multi-mode conversation of mobile terminals is provided, comprising the steps of:
a) detecting whether there is Wireless Local Area Network (WLAN) available nearby;
b) accessing a network device for correlative location information of another mobile terminal which it intends to communicate with when there is a WLAN available;
c) establishing communication with the another mobile terminal by using the correlative location information via the WLAN after receiving the correlative location information of the another mobile terminal sent back by the network device; and
d) accessing the network device to request updating correlative location information of the mobile terminal when the correlative location information of the mobile terminal changes.

According to the second aspect of the present invention, a mobile terminal for multi-mode conversation in mobile network is provided, comprising:
a first detecting means for detecting whether there is WLAN available nearby;
a searching means for accessing a network device for a correlative location information of another mobile terminal which it intends to communicate with when there is a WLAN available;
a conversation establishing means for establishing communication with the another mobile terminal by using the correlative location information via the WLAN after receiving the correlative location information of the another mobile terminal sent back by the network device; and
an information updating means for accessing the network device to request updating correlative location information of the mobile terminal when the correlative information of the network location of the mobile terminal changes.

According to the third aspect of the present invention, a method in network device for enabling mobile terminals to perform multi-mode conversation is provided, comprising the steps of:
(a) storing correlative information of a plurality of mobile terminals;
(b) sending correlative location information of another mobile terminal which the mobile terminal intends to establish communication with after receiving a searching request from one of the mobile terminals; and
(c) updating stored correlative location information of the mobile terminal after receiving a update request from the mobile terminal.

According to the fourth aspect of the present invention, a network device that enables mobile terminals to perform multi-mode conversation is provided, comprising:
a storing means for storing correlative location information of mobile terminals and updating the stored correlative location information of mobile terminal after receiving update request from one of the mobile terminals;
a transmitting means for transmitting the correlative location information of another mobile terminal which the mobile terminal intending to communicate with after receiving searching request from the mobile terminal;

With the method in the present invention, synchronization between mobile terminals and IMS can be achieved in IM-based wireless overlay network. Thus many problems with non-synchronization can be avoided. Further more, a live connection for exchanging information between user terminal (mobile terminal) and IMS during instant messaging communication is not necessary in the present invention, that reduce the power cost of mobile terminals obviously and the service load.

For a more complete understanding of the present invention and the advantages thereof, following description is made with the accompanying drawings.

### BRIEF DESCRIPTION OF THE DRAWINGS

Following description is made with the accompanying drawings, wherein:

FIG. 1 shows an example of IMS-based wireless overlay network;

FIG. 2 shows the function drawing of a mobile terminal showed in FIG. 1 that can perform multi-mode conversation via the connection with IMS2;

FIG. 3 shows the function drawing of the address-searching means in the mobile terminal showed in FIG. 2;

FIG. 4 shows the function drawing of the information-updating means in the mobile terminal showed in FIG. 1;

FIG. 5 shows the flow chart of the method for performing multi-mode conversation by contacting IMS2 in mobile terminal 1 showed in FIG. 2;

FIG. 6 shows flow chart of the method for updating user's correlative information to IMS2 in mobile terminal 1 showed in FIG. 2;

FIG. 7-9 respectively shows the flow chart that mobile terminal 1 registers or updatees its latest location information in IMS2 in different situations;

In the drawings same numerals indicate same or similar feature.

### DETAILED DESCRIPTION OF THE INVENTION

Detailed descriptions of the preferred embodiments of the present invention are as follows with attached drawings:

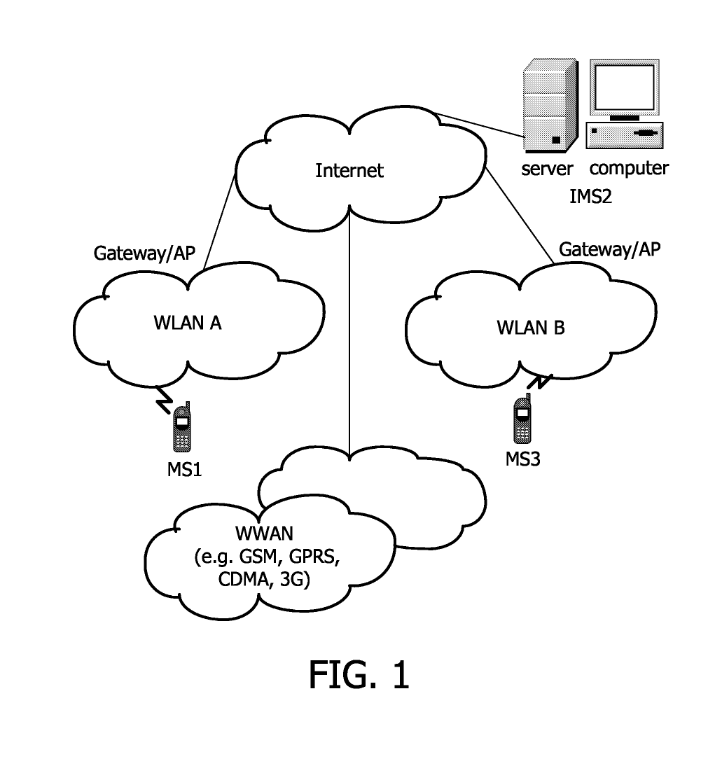

FIG. 1 shows a communication system disclosed in the first embodiment of the present invention, wherein comprises a Wireless Local Area Network (WLAN) A, a Wireless Wide Area Network (WWAN), an instant messaging service (IMS) 2 and a mobile terminal 1 that can perform multi-mode communication in WLAN or WWAN. The mobile terminal 1 has WLAN and WWAN interfaces. Mobile terminal 1 can get the contact information (including IP address) of mobile terminal 3 that is in WLAN B by contacting IMS2 in order to perform conversation with mobile terminal 3 via IP connection.

IMS2 comprises an active contact list, which stores user information like user's contacts information and user's preferred settings etc. Information in active contact list can be updated in a dynamic way to disclose user's latest situation and surroundings according to predefined updating principle and program. The IMS2 that comprises the active contact list may be located in Internet for providing public Internet services or in an intranet for providing services for all the stuff. Further more, there is a traditional IP connection between IMS2 and WWAN. In other words, active contact list in IMS2 can be possessed by WWAN operators to serve their users.

Detailed description of the main steps of the process that mobile terminal 1 performs multi-mode conversation by contacting IMS2 is given as below with FIG. 1 as reference:

### Step 1: Initializing Mobile Terminal 1

Mobile terminal 1 perform this step by corresponding operations when start-up, the operations comprises:
starting following setting process with pre-stored settings, the settings comprise:
   getting the network address of IMS2 (such as IP address), may including needed protocol/interface if necessary;
   informing of the user's ID in IMS2, can be cellular telephone number of other unique identifier;
   starting identifying failed connection and necessary switching with WLAN signal;
   informing IMS2 of the message that there is available WLAN;
   getting the IP address of mobile terminal 1 by manual assignment, DHCP(dynamic host configure protocol) or a scheme combined DHCP and manual assignment;
   determining the interval for confirming connection failure, the interval can be determined by mobile terminal 1 itself or on IMS2.

If some settings are not available or not valid, mobile terminal 1 will remind user to input them and store them in turn. In addition, default (custom-built) settings can be provided by manufacturer, service provider or user, user can modify the settings, too.

### Step 2: Detecting WLAN Signal, Managing Power, and Detecting Location

In this step, different operations may come from different mechanisms in WLAN system. The operations comprising:
waking WLAN modules and interfaces up. The method of waking up WLAN modules depends on the power consumption policy which is absolutely important for any mobile devices. Mobile terminal 1 can wake up WLAN modules and interfaces in following way;
   I. periodically waking up: mobile terminal 1 wakes up WLAN modules and interfaces, its interval may depends on whether mobile terminal is out of the WLAN network. If the mobile terminal is outside of the WLAN network, the interval can be longer than the one in the WLAN network reasonably to reduce the power cost. The practical value may be pre-set or calculated;
   II. event driven and policy limit: many events such as establishing conversation or changing setting scan can be used for triggering waking process;
   III. a combined scheme of I and II
detecting if there is WLAN nearby;
detecting if there is WLAN nearby when WLAN modules have not been waken up, if not, WLAN modules will go back to sleeping mode then be waken up according to corresponding policy.

### Step 3: Getting the IP Address, Performing the Authentication, Authorization and Accounting (AAA) of WLAN:

mobile terminal gets an IP address if there is a WLAN system and the mobile terminal can be configured automatically (or reconfigured); mobile terminal 1 gets/updates its IP address (automatic configure) and make it valid if relative WLAN changes. In some networks, the operation can be performed after the authentication process below;
WLAN AAA operation:

Correspondingly, some operations of this step can be performed before getting previous IP address, it depends on corresponding policy of WLAN system. AAA policy of WLAN mainly relates to user-based, MAC-based or other authentication methods and the combination of the methods;

If mobile terminal 1 doesn't be authorized to use WLAN system, it acts as no WLAN existence and jumps back to step 2;

If mobile terminal is authorized to use WLAN system, it will get an IP address and can accessing IMS2 and performing conversation via the WLAN using the IP address.

### Step 4: Registering or Updating Location Information in IMS2

Until now, mobile terminal 1 can access to IMS2 and choose registering or updating the user's information according to the situation that whether it is the first time to access to IMS2 or it want to updating its information. During the period in which mobile terminal 1 can access to IMS2, mobile terminal 1 will inform IMS2 about the changes of its location or other corresponding information periodically. Once IMS2 doesn't get any inform from mobile terminal 1 for a period, it will modify the user's information. And IMS2 can contact mobile terminal 1 forwardly or periodically for corresponding information.

If user is outside the WLAN coverage, other substitute contact methods beside mobile telephone number may be assigned. Further more, all the contact methods of mobile terminal 1′s user are arranged into a sequence so that other users can call mobile terminal 1's user with the substitute contact methods.

The communication between mobile terminal 1 and IMS2 can be encrypted with some encryption arithmetic.

Because IMS2 can store every user's preferred and substitute contact methods, the method in the present invention can be applied to users who have no WLAN/WWAN multi-mode terminal or even no mobile terminal. For example, a user only can register his/her telephone number and the IP address of VoIP (it can be IP address of PC or IP address of VoIP Gateway, user can enjoy VoIP service by using these IP addresses).

In addition, user can update the information in different ways such as WLAN, WWAN or paging etc.

### Step 5: Performing Conversation

In this step so-called “in WLAN coverage” means mobile terminal can transmit conversation via WLAN when “ outside WLAN coverage” means mobile terminal can't transmit conversation via WLAN. Calling and called station denotes the mobile terminal that corresponding users hold respectively.

Calling operation in conversation operation comprises following several scenes (this embodiment doesn't take switching and roaming into account):

### Scene 1: Calling Station and Called Station are Both Outside of WLAN Coverage

Calling station calls the called station with the latter's mobile telephone number via WWAN;

### Scene 2: Calling Station is in WLAN Coverage When Called Station is Not

Calling station will examine if the called station can be contacted via WLAN, if it is informed that it cannot contact the called station via WLAN, calling station will call the called station with the latter's mobile telephone number via WWAN;

### Scene 3: Called Station is in WLAN Coverage When Calling Station is Not

Since calling station is outside WLAN coverage, it will start another call via WWAN.

### Scene 4: Calling Station and Called Station are Both in WLAN Coverage

First, calling station tests and gets called station's IP address by the access to IMS2. When IMS2 gets the IP address of the called station, it will start a VoIP communication connection via WLAN.

Mobile terminal will keep updating the latest location information (including IP address) in IMS2. The appearance of the latest location information in IMS2 will trigger a switching process. For simple and clear description, it is assumed that the called station is in WLAN coverage and the calling station moves into/out of WLAN coverage, the switching process comprising:

### Scene 1: Calling Station Enters WLAN Coverage During a Conversation of WWAN

Because the operations in step 2 and step 3 is continuous during the calling station's active period, calling station knows that it is in WLAN coverage. In this situation, it will examine whether the called station can be contacted via WLAN. If so, get the called station's IP address and then switch the conversation from WWAN to WLAN by using corresponding signals.

### Scene 2: Calling Station is Leaving WLAN During a Conversation of WLAN

In this situation, calling station has known the mobile telephone number of the called station. When it is detected that WLAN signal is becoming weaker and getting closer to a pre-set threshold, calling station will start a call via WWAN then switch the conversation from WLAN to WWAN.

There is another kind of calling operation that can be performed between different kinds of users in different ways beside the calling operation between mobile terminals. For example, called station registers its VoIP gateway with its telephone number. Calling station searches the called station's information on active contacts list and gets the IP address of VoIP gateway. Then, calling station will start a call from an already known VoIP gateway to called station.

### Step 6: Tailing WLAN Connection

This operation may be considered as the continuing of step 2 and step 3, mobile terminal will test the signal intensity of WLAN and the usability of WLAN system continuously. If it finds signal lost or connection denied, it will go back to step 2, then adjust the working mode of mobile terminal to a suitable mode. Besides, active contacts list can tail and update the user information continuously, this operation can be performed according to pre-set principle, changes of environment or temporary sleep (maybe no message comes for a period of time) or other factors.

During the whole process, pre-set parameters (denoting corresponding principle and environment) will be configured automatically or reset according to practical situation.

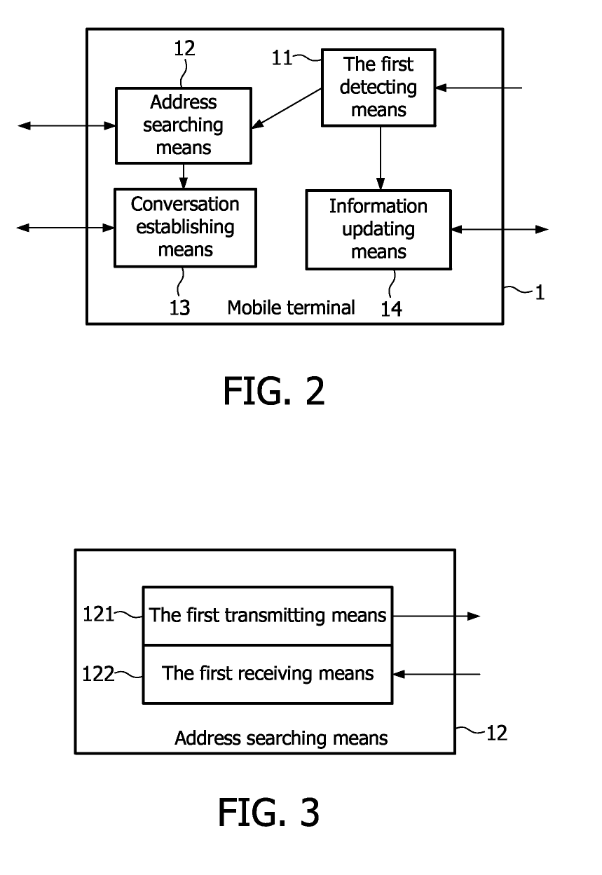

FIG. 2 shows the function drawing of mobile terminal 1 showed in FIG. 1 that can perform multi-mode conversation by contacting IMS2. More particularly mobile terminal 1 supports cellular voice conversation and VoIP, also comprises a first detecting means 11, a address-searching means 12 and a conversation establishing means 13.

The first detecting means 11 is used for detecting whether there is an available WLAN, more particularly is for detecting if there is an available WLAN periodically or based on event triggering.

Address-searching means 12 is used for the access to IMS2 for searching the IP address of another mobile terminal (mobile terminal 3) that mobile terminal 1 need to communicate with when the first detecting means 11 find an available WLAN nearby. Besides, address-searching means 12 is also in charge of detecting and getting the address information of the WLAN (mainly comprised by its IP address) then inform IMS2 of the address information of WLAN.

Conversations establishing means 13 is for selecting conversation method and establishing conversation including switching between VoIP over WLAN and traditional conversation over WWAN, detecting wireless signal and managing power. Particularly, when there is WLAN available nearby and address searching means 12 has gotten the IP address of another mobile terminal which mobile terminal 1 need to communicate with, conversation establishing means 13 can use the IP address of the another mobile terminal to establish communication via the WLAN; otherwise, if there is no WLAN available nearby or address searching means 12 hasn't got the IP address of another mobile terminal, communication will be established via traditional WWAN.

Mobile terminal 1 also comprises an information-updating means 14 used for accessing IMS2 to register or update its location information or IP address in IMS2 when its location information or IP address changes.

FIG. 3 shows the function drawing of the address-searching means 12 in the mobile terminal shown in FIG. 2. The address-searching means 12 comprises a first transmitting means 121 and a first receiving means 122. Wherein the first transmitting means 121 is for transmitting a searching request to IMS2 for the correlative information of another mobile terminal that it need to communicate with; while the first receiving means 122 is for receiving a location information response message from IMS2, including the IP address of another mobile terminal it need to communicate with or the inform that no information about the IP address of another mobile terminal it need to communicate with.

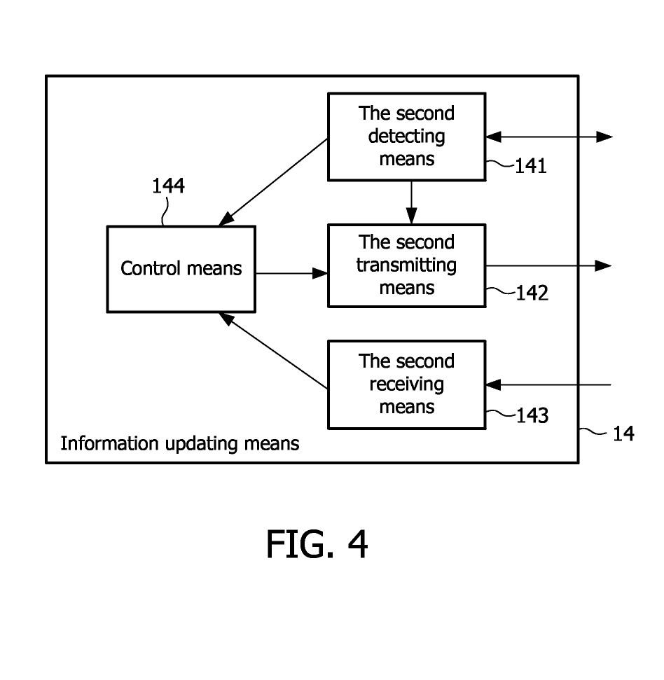

FIG. 4 shows the function drawing of the information-updating means 14 of the mobile terminal shown in FIG. 1. The information-updating means 14 comprises a second detecting means 141 and a second transmitting means 142. Wherein second detecting means 141 is for monitoring the location information or IP address of mobile terminal 1 continuously for any changes; second transmitting means is for sending an update request message (comprising the new location information or IP address) to IMS2.

Information updating means 14 also comprises a second receiving means 143 and a control means 144, wherein second receiving means 143 is for receiving the response message from IMS2 after the second transmitting means have sent the update request message to IMS2; control means 144 is for controlling the second transmitting means 142 to send update request message to IMS2 again if there is no response message from the network device for a period of time.

The second detecting means 141 is also for detecting if mobile terminal 1 has moved to a network of a new kind. If so, then test whether the former network route is still available; control means 144 is also for sending update request message to IMS2 via the former route if the former route is still available.

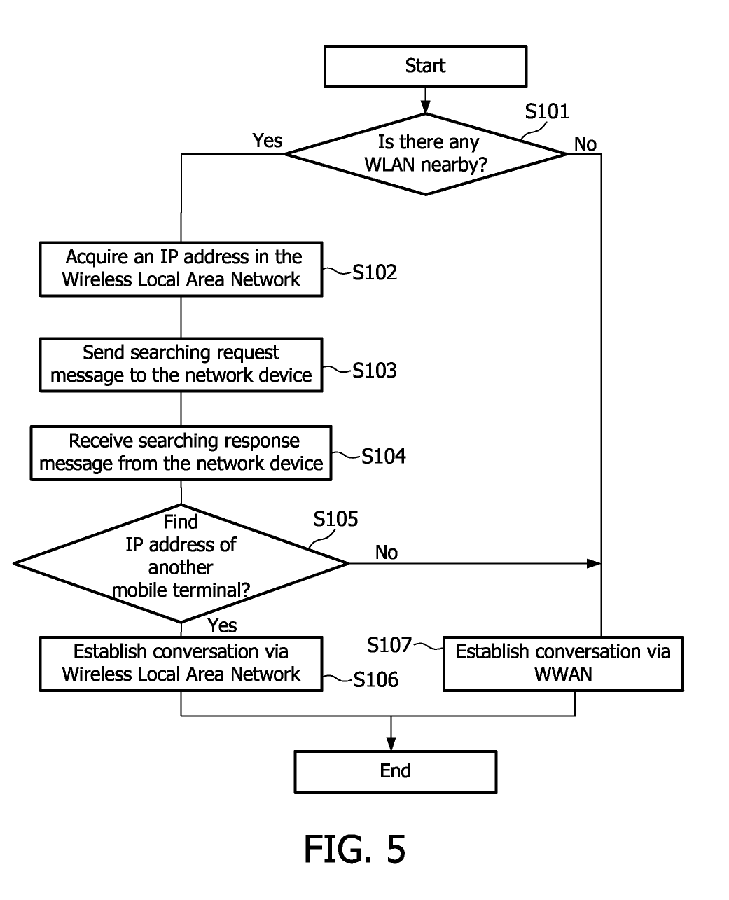

FIG. 5 shows the flow chart of the method for performing multi-mode conversation by contacting IMS2 in mobile terminal 1 showed in FIG. 2.

In step S101, mobile terminal 1 detects whether there is WLAN available nearby. If so, go to step S102, if not, go to step S107 that establishing a conversation via WWAN;

In step S102, mobile terminal gets one IP address from the WLAN, then go to step S103;

In step S103, mobile terminal 1 sends a searching request message to IMS2 for searching the IP address of another mobile terminal, which it needs to communicate with.

Then in step 104, mobile terminal 1 receives the response message from IMS2. The response message can be the IP address of another mobile terminal which mobile terminal 1 needs to communicate with or informs about that there is no message of the IP address of another mobile terminal;

In step S105, mobile terminal 1 estimates if the IP address of another mobile terminal has been found according to the request. If so, go to step S106, if not, then go to step S107;

In step S106, mobile terminal 1 establishes a conversation via the WLAN according to the IP address of another mobile terminal that has already been found;

In step S107, mobile terminal 1 still establishes conversation via WWAN.

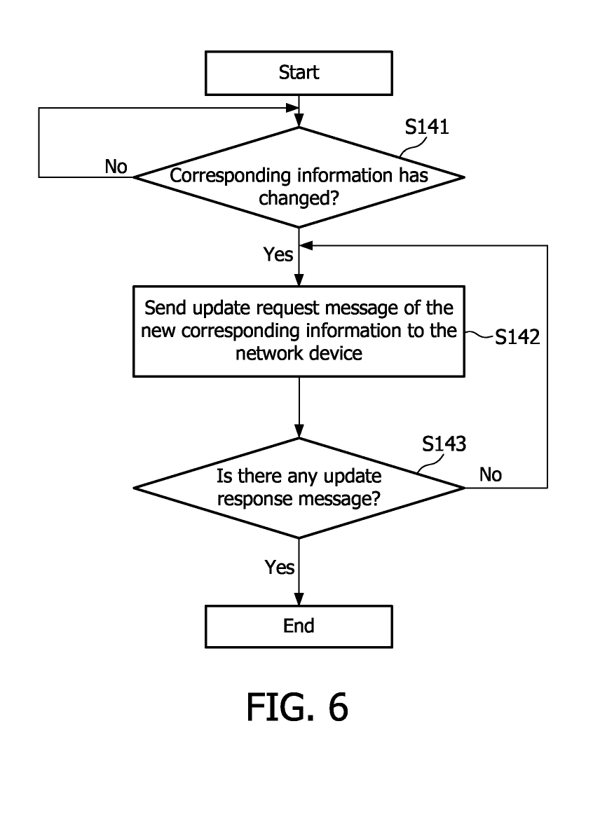

FIG. 6 shows flow chart of the method for updating user's correlative information to IMS2 in mobile terminal 1 showed in FIG. 2.

In step S141, mobile terminal 1 tests if there is any change of its location information or IP address. If so, then go to S142, if not, then keep detecting;

In step S142, mobile terminal 1 sends an update request message (comprising the new location information or IP address) to IMS2 then goes to S143;

In step S143, mobile terminal 1 estimates if it has received any response message from IMS2 during a definite period of time. If so, the whole process is over, if not, go back to step S142, send the update request message to IMS2 again.

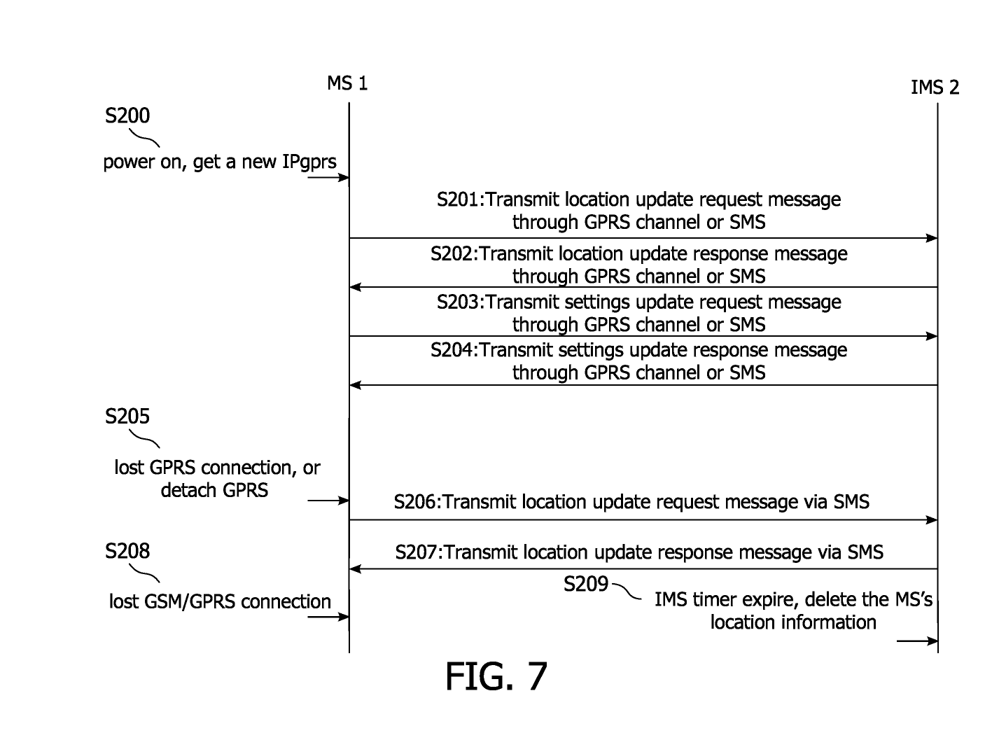

FIG. 7-9 shows the flow chart that mobile terminal 1 registers or updates its latest location information in IMS2 in different situations respectively:

Wherein, FIG. 7 shows the situation that mobile terminal 1 is in GPRS network: when mobile terminal (MS) 1 starts up, registers in a GPRS network and gets an IP address (denoted as IP_{GPRS}) (step S200).

After logging on to IMS2, MS1 will send its update request message of the latest location information including IP address (IP_{GPRS}) to IMS2 through GPRS channel or SMS (step S201).

After receiving the message, IMS2 updates its database then sends a location information update request response message back to MS1 through GPRS channel or SMS (step S202).

MS1 can also request update because of the changes of other information. For example, the changes of user settings can be sent in the location information update request message or a special settings update request message (step S203) then IMS sends corresponding settings update request response message back (step S204).

The communication route from MS1 to IMS2 can be the same with the one from IMS2 to MS1 or not.

After MS1 has logged on to IMS2 and before the location information of MS1 changes, the location information or other information of MS1 and be updated with normal instant messaging communication method so that the information stored in IMS2 is accordant to the current information of MS1. Usually, the communication route between IMS2 and MS1 is the same with the one in the process that MS1 initially logs on to IMS2.

If MS1 leaves GPRS network or loses the GPRS connection (step S205), it must informs IMS2 of its latest location information, the inform message can be sent via SMS (step S206).

After receiving location update request information, IMS2 will instantly update the database then send back a response message to MS1 (step S207).

Further more, IMS2 can call MS1 periodically. If MS1 loses GSM/GPRS connection suddenly and can't rebuild the connection in a short while because it moves out of GSM/GPRS overlay or is power off (step S208), then IMS2 can't receive the response from MS1. Then IMS2 starts a corresponding timer, if the connection has not been established again before the timer stops, IMS will delete the location information of MS1, that means update is to “not connected”, “unidentified” or some other status (step S209).

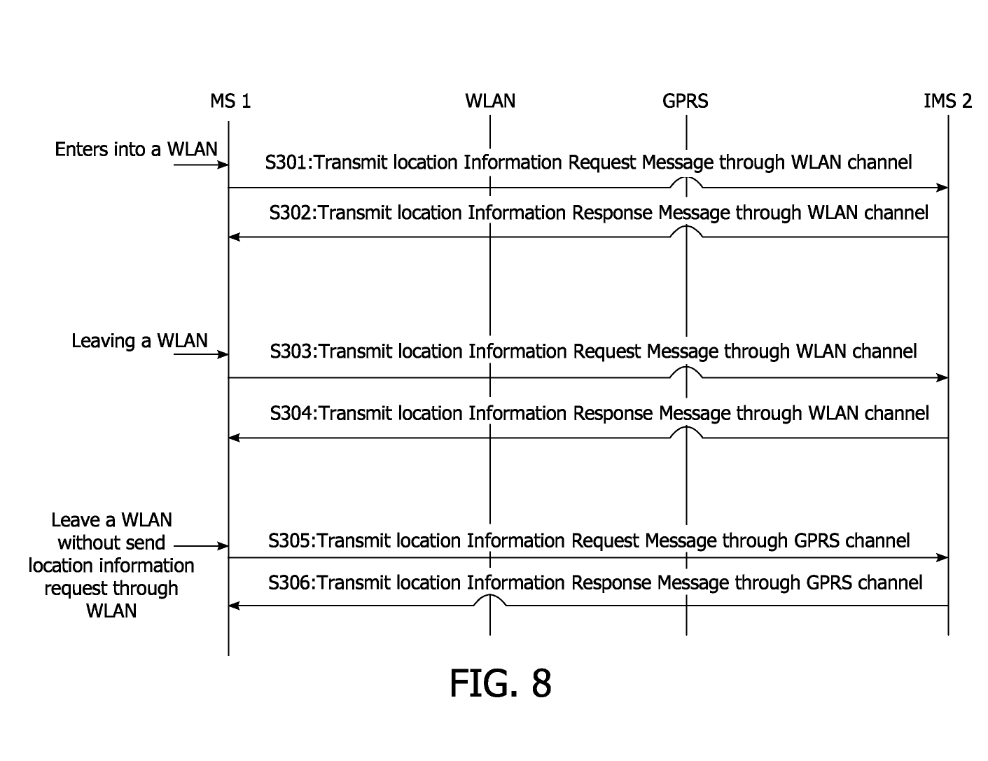

FIG. 8 shows the flow chart of the process that MS1 updates its latest location information when it leaves/enters WLAN:

In this figure, “Enter” WLAN means that MS1 enters WLAN coverage and the contact and authentication happens between MS1 and WLAN, MS1 gets an IP address (denoted as IP_{WLAN}) from WLAN, becomes able to use WLAN services and can contact IMS2 through WLAN channel. “Leave” WLAN means that MS2 can't contact with IMS2 via WLAN which is formerly available. Maybe because it has moved out of WLAN coverage or the route between WLAN and IMS2 has been cut off.

When MS1 enters WLAN, it sends location update request message including IP address (IP_{WLAN}) to IMS2 through the WLAN channel (step S301). Received the message, IMS2 updates its database and sends the location update response message back via WLAN channel (step S302).

If GPRS communication channel has been established before MS1 enters WLAN, then MS1 can send the new message via GPRS using instant messaging communication method between MS1 and IMS2.

Other information can be sent and updated with the preceding method if needed.

When MS1 stays in WLAN and its location information doesn't change, then keeps the information update with IMS2 by using normal instant messaging communication method.

When MS1 leaves WLAN, if MS1 can test that if it has moved out of the WLAN coverage, it can send location update request message to ask IMS2 to delete IP_{WLAN} or denote it as invalid (step S303). IMS2 then updates its database and sends back the location update response message through WLAN channel (step S304).

If MS1 has received the location update response message from IMS2, then it will not need to send new location update request message when it moves out of WLAN coverage. If MS1 hasn't received the response from IMS2 before it leaves WLAN, it can send new location update request message through GPRS channel or SMS (step S305). Then IMS2 transmits location update request response message through GPRS channel or SMS, too.

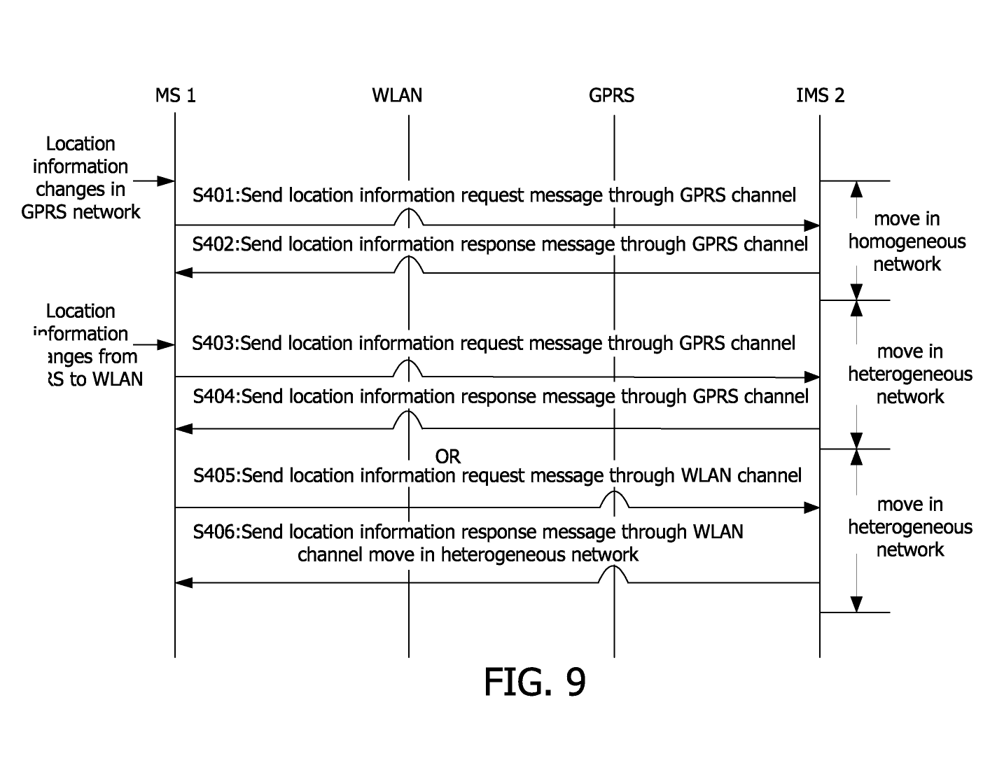

FIG. 9 shows the flow chart of the operation process that mobile terminal 1 updates its latest location information during an active conversation:

If the location information of MS1 changes during an active conversation between the MS1 and another mobile terminal, then updating the location information between MS1 and IMS2 or not can depend on whether the changes of location information will affect the succedent conversation. If not, MS1 doesn't need to start the location information update process immediately; if so, MS1 must start the update process immediately. Following expositive words will focus on starting location information update process immediately for example.

When location information changes when MS1 enters a network of the same kind, such as from GPRS to GPRS, or from WLAN to WLAN, the updating of location information can be accomplished by using instant messaging communication method, corresponding location update request message and location update request response message can be transmitted via GPRS (step S401 and S402).

When location information changes when MS1 enters a network of another kind, such as from GPRS to WLAN (vice versa), there are several methods to accomplish the operation of updating its latest location information. If the initial transmitting route is still available when the location information changes, then the route could will still be used for transmitting location update/response message between MS1 and IMS2, GPRS for example (step S403 and S404); if the initial route is not available any more, then use the route of the new network or if there is no response when using initial route (GPRS) to transmit location update request message, then the new location update request message can be accomplished via the new network, WLAN for example (step S405 and S406).

Usually, a live connection is needed for exchanging information between user terminal (MS1) and IMS2 in instant messaging communication. But in the present invention, no need for it.

Specifically, MS1 exchanges essential information with IMS2 when logs on to the latter in the present invention then logs out. After logging out, if the location information of MS1 has no changes, then there is no need for keeping live connection between MS1 and IMS2. That reduces the power cost of MS1 and the service quantity of network.

The update process of the location information of MS1 can also be initiated by IMS2, particular process is showed as follows:

Usually, the update process of location information is always initiated by MS1 when it finds the location has changed. Besides, IMS2 can examine the validity of a user's location information with calling process. IMS2 can send a confirm request message to MS1, the location is where MS1 announces it is currently. If MS1 is there, it will make response. If IMS2 receives no response, it will deem that the location is not valid any longer then delete the location from the list for MS1.

A third party can also be used for updating the location information of MS1. For example, when MS3 wants to contact with MS1, MS3 sends location information search message to IMS2 for the current location of MS1. IMS2 replies with the location information of MS1 it stored. MS3 contacts MS1 with the location information. If it can't reach MS1 when using the location information it got as the destination address, MS3 can report to IMS2 that the location address of MS1 is now unavailable. IMS2 then updates the location information of MS1 immediately or sends a confirm request message to MS1 to check if its location address is still valid. If no response from MS1 or MS1 replies that the address is not valid via another route to IMS2, then IMS2 will update the location information of MS1 in its database.

Using the method in the present invention, dynamic update of information between MS and IMS can be achieved in IM-based wireless overlay network. Thus, many problems came with the disaccord between the information stored in IMS and the current information of MS can be avoided.

Although the present invention has been described in detail, it should be understood that various changes, substitutions and alterations can be made hereto without departing from the spirit and scope of the invention as described by the appended claims.

1. A method for performing multi-mode conversations for mobile terminals, comprising the steps of:
a) detecting whether there is Wireless Local Area Network (WLAN) available nearby;
b) accessing a network device for correlative location information of another mobile terminal which it intends to communicate with when there is a WLAN available;
c) establishing communication with said another mobile terminal by using said correlative location information via said WLAN after receiving said correlative location information of said another mobile terminal sent back by said network device; and
d) accessing said network device to request updating correlative location information of said mobile terminal when said correlative location information of said mobile terminal changes.

2. The method according to claim 1, further comprising the step of:
establishing communication with said another mobile terminal via a Wireless Wide Area Network (WWAN) if there is no WLAN available nearby.

3. The method according to claim 1, further comprising the step of:
establishing communication with said another mobile terminal via a WWAN, when not receiving said correlative location information of said another mobile terminal sent by said network device.

4. The method according to claim 1, wherein said correlative location information of said mobile terminal and said correlative location information of said another mobile terminal comprise information about IP address respectively.

5. The method according to claim 1, before step a), further comprising a step of
registering said correlative location information of said mobile terminal in said network device.

6. The method according to claim 1, further comprising the steps of:
e) detecting whether said mobile terminal has moved into another kind of network;
f) detecting whether detecting said mobile terminal's former network route is still usable when said mobile terminal enters said another kind of network;
g) transmitting update request message of correlative location information of said mobile terminal to said network device via said former network route if said former route is still usable; and
h) transmitting said update request message of correlative location information of said mobile terminal to said network device via said another kind of network if said former route is not usable any longer;

7. A mobile terminal for performing multi-mode conversations, comprising:
a first detecting means for detecting whether there is WLAN available nearby;
a searching means for accessing a network device for a correlative location information of another mobile terminal which it intends to communicate with when there is a WLAN available;
a conversation establishing means for establishing communication with said another mobile terminal by using said correlative location information via said WLAN after receiving said correlative location information of said another mobile terminal sent back by said network device; and
an information updating means for accessing said network device to request updating correlative location information of said mobile terminal when said correlative information of the network location of the mobile terminal changes.

8. The mobile terminal according to claim 7, wherein said conversation establishing means is further for establishing communication with said another mobile terminal via a WWAN if there is no WLAN available.

9. The mobile terminal according to claim 7, wherein said conversation establishing
means is further for:
establishing communication with said another mobile terminal via a WWAN when no correlative location information of said another mobile terminal is received;

10. The mobile terminal according to claim 7, wherein said information updating means is further for registering correlative location information of said mobile terminal in said network device.

11. The mobile terminal according to claim 10, wherein said information updating means comprising:
a second detecting means for detecting whether said correlative location information of said mobile terminal has changed;
a transmitting means for transmitting update request message of correlative location information of said mobile terminal to said network device when said correlative location information of said mobile terminal has changed.

12. The mobile terminal according to claim 7, wherein:
said first detecting means is further for detecting whether said mobile terminal has moved into another kind of network and whether said mobile terminal's former network route is still available when said mobile terminal enters said another kind of network; and
said information updating means if further for transmitting said update request message of correlative location information of said mobile terminal to said network device via said former network route when said former route is still available and transmitting said update request message of correlative location of said mobile terminal to said network device via said another kind of network when former route is not available any longer;

13. A method used in network device for enabling mobile terminals to perform multi-mode conversations, comprising the steps of:
(a) storing correlative information of a plurality of mobile terminals;
(b) sending correlative location information of another mobile terminal which said mobile terminal intends to establish communication with after receiving a searching request from one of said mobile terminals; and
(c) updating stored correlative location information of said mobile terminal after receiving an update request from said mobile terminal.

14. The method according to claim 13, further comprising steps of:
(d) sending confirm request of correlative location information to said mobile terminal; and
(e) updating said stored correlative location information of said mobile terminal when no response from said mobile terminal received in a predefined period;

15. The method according to claim 13, wherein said correlative location information of mobile terminals comprises IP address information of corresponding mobile terminal;

16. The method according to claim 13, wherein in step (b), informing said mobile terminal of there is no available correlative location information when no said correlative location information of said another mobile terminal is found.

17. A network device that supporting mobile terminals to perform multi-mode conversations, comprising:
a storing means for storing correlative location information of mobile terminals and updating said stored correlative location information of mobile terminal after receiving update request from one of the said mobile terminals;
a transmitting means for transmitting the correlative location information of another mobile terminal which said mobile terminal intending to communicate with after receiving searching request from said mobile terminal;

18. The network device according to claim 17, wherein said transmitting means is further for transmitting confirm request of correlative location information to said mobile terminal, said storing means is further for updating said stored correlative location information when no response from said mobile terminal received in a predefined period;

19. The network device according to claim 17, wherein said transmitting means is further for informing said mobile terminal of there is no available correlative location information of said another mobile terminal if no correlative location information of said another mobile terminal is found.
